(19) United States
(12) Patent Application Publication
(10) Pub. No.: US 2024/0165435 A1
(43) Pub. Date: May 23, 2024

(54) A CONNECTOR FOR A FLUIDIC CIRCUIT

(71) Applicant: SINGAPORE HEALTH SERVICES PTE LTD, Singapore (SG)

(72) Inventors: Meng Kwang Jansen KOH, Singapore (SG); Roshni Sadashiv GOKHALE, Singapore (SG); Leylane ANSELMO, Singapore (SG); Yan Chen Nigel CHEW, Singapore (SG); Vernon CHEN, Singapore (SG)

(21) Appl. No.: 18/551,573

(22) PCT Filed: Mar. 23, 2022
(86) PCT No.: PCT/SG22/50160

§ 371 Date: Sep. 20, 2023

(30) Foreign Application Priority Data
Mar. 23, 2021 (SG) 10202103008V

(51) Int. Cl. A62B 9/04; A62B 9/02

(52) U.S. Cl. CPC A62B 9/04; A62B 9/02

(57) ABSTRACT

A connector for a fluidic circuit and a method for assembling the connector are disclosed. The connector includes a valve body having at least three ports comprising first and second inlet ports and an outlet port; and a valve switch attached to the valve body, the valve switch being movable between a plurality of positions relative to the valve body; wherein, in a first position, the valve switch is configured to fluidically connect the first inlet port to the outlet port, and fluidically seal the second inlet port from the outlet port; and wherein, in a second position, the valve switch is configured to fluidically connect the second inlet port to the outlet port, and fluidically seal the first inlet port from the outlet port.

### FIELD OF INVENTION

The present disclosure relates broadly, but not exclusively, to a connector for a fluidic circuit and a method for assembling a connector for a fluidic circuit.

### BACKGROUND

Covid-19 patients who become seriously ill requires intubation and mechanical ventilation for severe hypoxemia. Once connected to the intensive care unit (ICU) ventilator, a closed circuit is formed between the patient and the ventilator, allowing maintenance of lung pressure for oxygenation as well as preventing aerosolizing of SARSCoV-2. Transfers of intubated COVID-19 patients out of the ICU are often required within the hospital, for example, for radiological investigation and interventional procedures. Transfer of patients may also occur between hospitals for advanced ventilation procedures when escalation of care is required. Such transfers require a patient to be disconnected from the ICU ventilator and connected to the transport ventilator.

The transfer of intubated, critically ill patients with COVID-19 poses two main problems when the patient is disconnected from the ICU ventilator and connected to the transport ventilator. Firstly, the pressure required to maintain oxygenation in such patients is often lost when ventilators are switched, resulting in potential harm to the patient who are already severely hypoxemic from COVID-19. Secondly, significant aerosolization occurs when the patient is transiently disconnected from the ICU ventilator to the transport ventilator, which poses a risk to the healthcare personnel.

Accordingly, a need exists to provide a connector for a fluidic circuit that seeks to address some of the above problems.

### SUMMARY

According to a first aspect of the present invention, there is provided a connector for a fluidic circuit, the connector comprising: a valve body having at least three ports comprising first and second inlet ports and an outlet port; and a valve switch attached to the valve body, the valve switch being movable between a plurality of positions relative to the valve body; wherein, in a first position, the valve switch is configured to fluidically connect the first inlet port to the outlet port, and fluidically seal the second inlet port from the outlet port; and wherein, in a second position, the valve switch is configured to fluidically connect the second inlet port to the outlet port, and fluidically seal the first inlet port from the outlet port.

In an embodiment, the first and second inlet ports are configured to be connected to first and second fluid sources, respectively, and wherein the outlet port is configured to be connected to a filter device.

In an embodiment, the first and second inlet ports and the outlet port each comprise an internal diameter having the same dimension as an internal diameter of the filter device.

In an embodiment, the valve body comprises a receptacle fluidically connected to each of the outlet port and first and second inlet ports, and wherein the valve switch is disposed in the receptacle such that the valve switch is rotatable between the plurality of positions.

In an embodiment, the inlet port, first outlet port and second outlet port are angularly spaced from each other.

In an embodiment, the valve switch comprises a plurality of holes configured to selectively connect the first inlet port to the outlet port in the first position, and to selectively connect the second inlet port to the outlet port in the second position.

In an embodiment, the connector further comprises at least one seal disposed at an interface between the valve body and valve switch, wherein the at least one seal is configured to maintain a positive pressure of up to 30 cmH2O in the connector in use.

In an embodiment, the valve switch further comprises a visual indicator configured to indicate which of the first and second inlet ports is opened.

In an embodiment, a fluidic circuit includes: a first fluid source; a second fluid source; and the connector according to the first aspect, wherein the first and second inlet ports of the connector are configured to be connected to first and second fluid sources respectively.

In an embodiment, the first fluid source comprises a first ventilator and the second fluid source comprises a second ventilator.

In an embodiment, the first ventilator comprises an intensive care unit ventilator and the second ventilator comprises a transport ventilator.

According to a second aspect of the present invention, there is provided a method for assembling a connector for a fluidic circuit, the method comprising: providing a valve body having at least three ports comprising first and second inlet ports and an outlet port; and disposing a valve switch in the valve body such that the valve switch is movable between a plurality of positions relative to the valve body; wherein, in a first position, the valve switch is configured to fluidically connect the first inlet port to the outlet port, and fluidically seal the second inlet port from the outlet port; and wherein, in a second position, the valve switch is configured to fluidically connect the second inlet port to the outlet port, and fluidically seal the first inlet port from the outlet port.

In an embodiment, attaching the valve switch to the valve body comprises disposing the valve switch in the receptacle such that the valve switch is rotatable between the plurality of positions.

In an embodiment, the method further comprises disposing at least one seal at an interface between the valve body and valve switch such that the at least one seal maintains a positive pressure of up to 30 cmH2O in the connector in use

In an embodiment, attaching the valve switch to the valve body comprises positioning the valve switch such that the visual indicator indicates which of the first and second inlet ports is opened.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a perspective view of a connector for a fluidic circuit, according to an example embodiment.

FIG. 2A shows a side view of a first inlet port of the connector of FIG. 1, according to an example embodiment.

FIG. 2B shows a side view of the connector of FIG. 2A with the valve switch and cover removed.

FIG. 3A shows a side view of a second inlet port of the connector of FIG. 1, according to an example embodiment.

FIG. 3B shows a side view of the connector of FIG. 3A with the valve switch and cover removed.

FIG. 4 shows a cross-sectional close-up view of a port of the connector of FIG. 1, according to an example embodiment.

FIG. 5 shows a flow chart illustrating a method for assembling a connector for a fluidic circuit, according to the example embodiments.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. Herein, a connector for a fluidic circuit, a fluidic circuit having such a connector, and a method for assembling the connector are presented in accordance with present embodiments having the advantages of being lightweight, small in size to minimize dead space and disposable to facilitate infection control purposes. The connector can be fluidly connected to a breathing circuit of a patient and may maintain air pressure within the patient to minimize aerosolization through escape of exhaled air. Being lightweight and disposable may allow manufacturing of the connector in significant quantities for routine use for all COVID-19 patients, COVID-19 suspected cases and all patients requiring invasive mechanical ventilation.

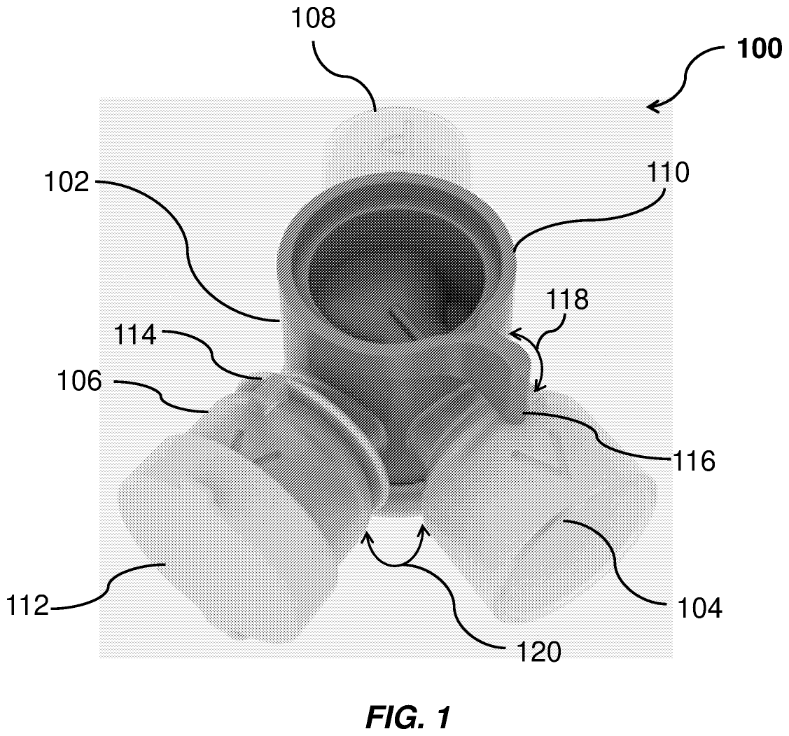

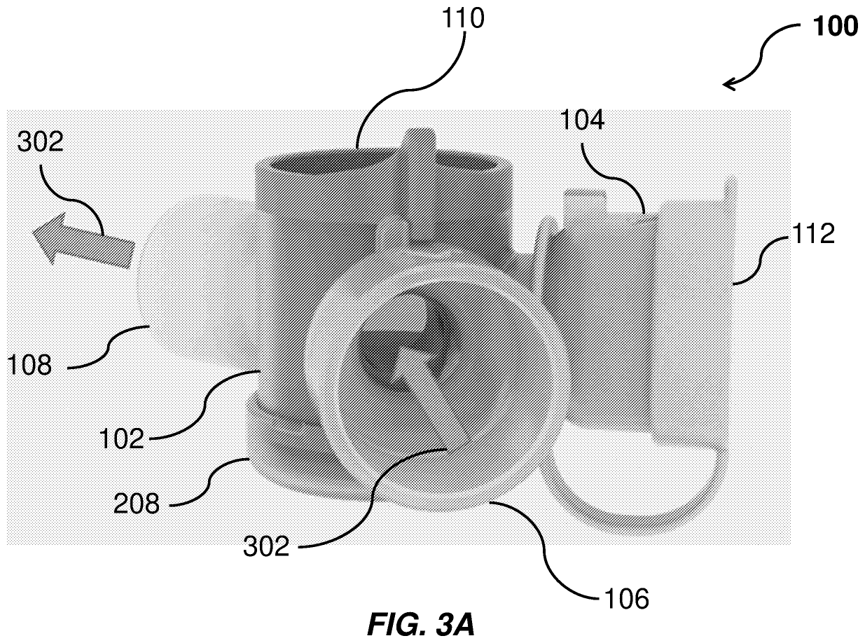

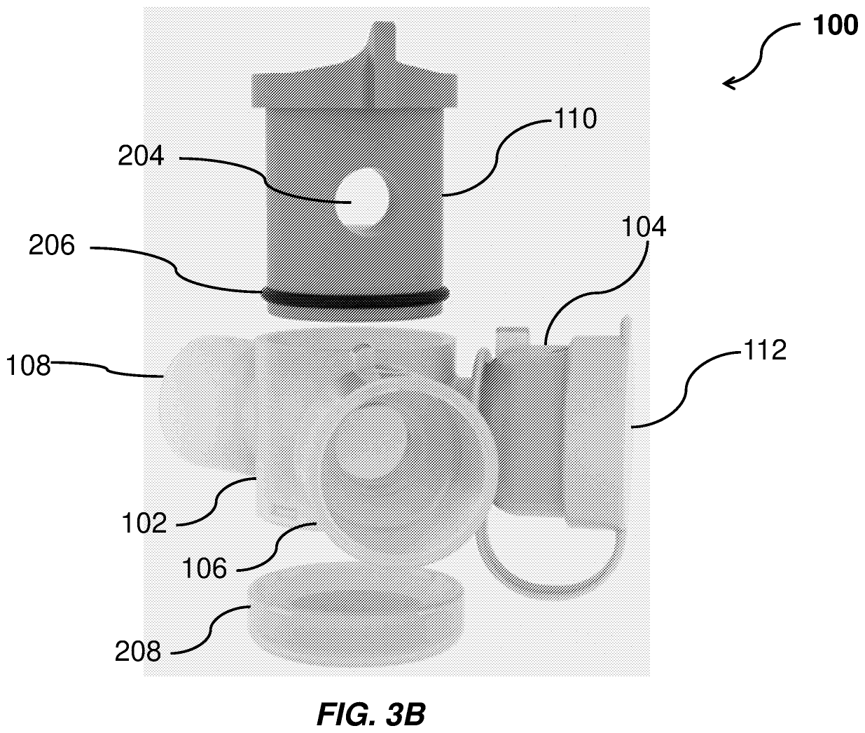

FIG. 1 shows a perspective view of a connector 100 for a fluidic circuit, according to an example embodiment. The connector 100 includes a valve body 102 having at least three ports, comprising a first inlet port 104, a second inlet port 106 and an outlet port 108. The connector 100 also includes a valve switch 110 attached to the valve body 102. The valve switch 110 may be removably attached to the valve body 102 and may be movable between a plurality of positions relative to the valve body 102. As shown in FIG. 1, the valve switch 110 is in a first position to fluidically connect the first inlet port 104 to the outlet port 108 and fluidically seal the second inlet port 106 from the outlet port 108. In a second position (shown in FIG. 3A), the valve switch 110 is configured to fluidically connect the second inlet port 106 to the outlet port 108 and fluidically seal the first inlet port 104 from the outlet port 108.

The connector 100 may include a cap 112 to physically seal the inlet port that is not in use in order to maintain cleanliness. The cap 112 may be made from rubber or silicone (or any other materials) and is removable from the valve body 102. Each of the first inlet port 104 and the second inlet port 106 may have a limiter 114 in order to align the valve switch 110 with the respective inlet port to the outlet port 108. The limiter 114 can serve as a guide for a user to fully engage the valve switch 110 with the respective port and reduce errors on partial or non-alignment of the ports.

The valve switch 110 may have a visual indicator 116 configured to indicate which of the first and second inlet ports 104, 106 is opened. As shown in FIG. 1, the visual indicator 116 points to the first inlet port 104 indicating that the first inlet port 104 is opened and fluidically connected to the outlet port 108. This also indicates that the second inlet port 106 is fluidically sealed from the outlet port 108. Accordingly, a user can control fluid (e.g. air or oxygen) access within the connector 100 by moving the valve switch 110 and taking reference to the visual indicator 116 to indicate the inlet port with which the valve switch 110 is opened.

The first inlet port 104, the second inlet port 106 and the outlet port 108 may be angularly spaced from each other, which can reduce air turbulence within the breathing circuit. In an example embodiment, each of the first inlet port 104 and the second inlet port 106 is at an obtuse angle 118 (e.g. 120°) to the outlet port 108. Such an angle may minimize turbulence and prevent kinking within the connector 100. It can be appreciated that the angle 118 between the outlet port 108 and each of the first inlet port 104 and the second inlet port 106 may be at a non-obtuse angle. The first inlet port 104 and the second inlet port 106 are at an acute angle 120 (e.g. 60°) with each other to facilitate the ease of switching the connections between the first inlet port 104 and the second inlet port 106. It can be appreciated that the first inlet port 104 and the second inlet port 106 may be at an angle 120 that is not acute.

The connector 100 may be attached to the breathing circuit by an overmount feature. In other words, the connector 100 attaches to the breathing circuit by fully enclosing (“cupping”) the breathing circuit at the connection site. Moreover, the ports 104, 106, 108 of the connector 100 may have at least the same diameter as the smallest diameter within the entire breathing circuit so that airway resistance is not increased. Accordingly, the pressure of a fluid flow (e.g. air or oxygen) is not suddenly altered by a change in diameter. In an alternate embodiment, the connector 100 can also be designed to be undermounted, specifically having the breathing circuit to enclose (“cup”) the connector 100.

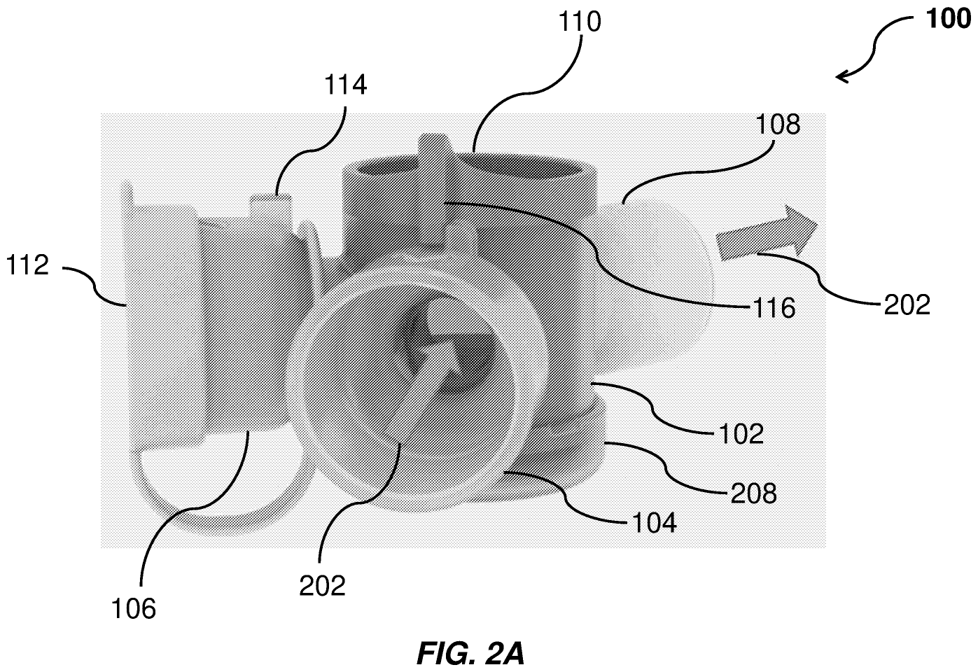

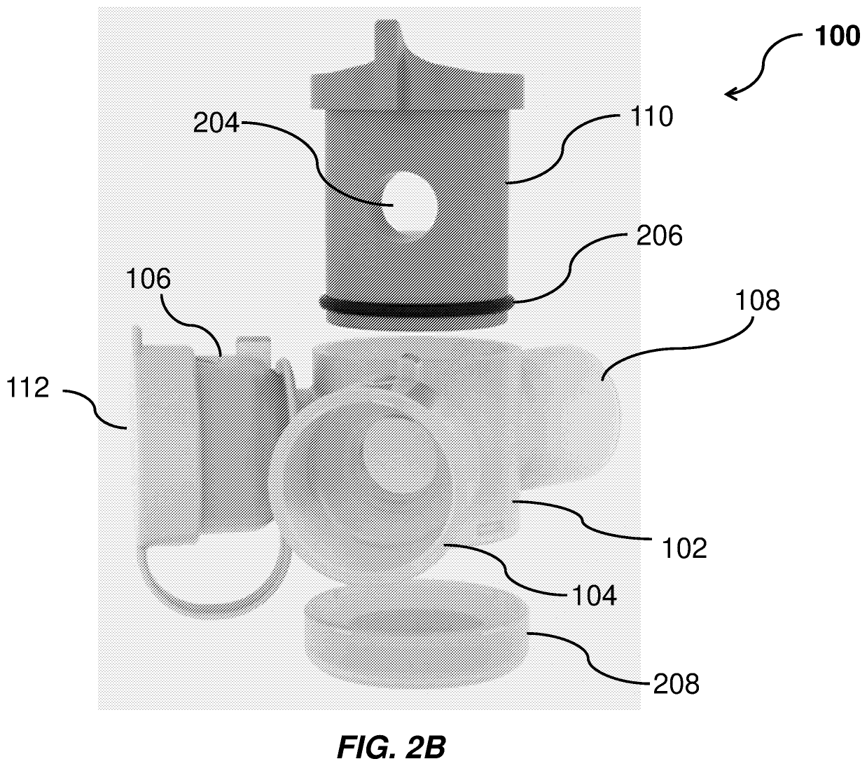

FIG. 2A shows a side view of a first inlet port 104 of the connector 100 of FIG. 1, according to an example embodiment. The first and second inlet ports 104, 106 may be configured to be connected to first and second fluid sources respectively and the outlet port 108 is configured to be connected to a filter device. The first fluid source may be a first ventilator and the second fluid source may be a second ventilator. For example, the first inlet port 104 may be an ICU ventilator port that is connected to an ICU ventilator while the outlet port 108 may be a Heat and Moisture Exchanger (HME) filter port having a HME filter that leads to the patient. The connector 100 may include a cover 208 removably attached to a bottom surface of the valve body 102 opposite the valve switch 110. The valve body 102 may include a seal (not shown in the Figure) disposed at an interface between the cover 208 and the valve body 102. It can be appreciated that, in alternate embodiments, the cover 208 can be part of the valve body 102 forming a single component. The cover 208 can reduce air leaks between the valve switch 110 and the valve body 102.

In the example embodiment shown in FIG. 2A, the valve switch 110 is at the first position whereby the first inlet port 104 is fluidically connected to the outlet port 108 while the second inlet port 106 is fluidically sealed from the outlet port 108. The removable cap 112 is used to physically seal the second inlet port 106 port to maintain cleanliness. The first inlet port 104 is fluidly connected to the first fluid source (e.g. an ICU ventilator) and the outlet port 108 is fluidically connected to the patient via the filter device (e.g. HME filter). The through connection can allow fluid (e.g. air or oxygen from the ICU Ventilator) to flow from the first fluid source unidirectionally (see arrows 202) through the connector 100 to the patient via the filter device (e.g. HME filter).

FIG. 2B shows a side view of the connector 100 of FIG. 2A with the valve switch 110 and the cover 208 removed. The valve body 102 includes a receptacle fluidically connected to each of the outlet port 108 and first and second inlet ports 104, 106. The valve switch 110 is disposed in the receptacle such that the valve switch 110 is rotatable between the plurality of positions. The valve switch 110 also includes a plurality of holes 204 configured to selectively connect the first inlet port 104 to the outlet port 108 in the first position, and to selectively connect the second inlet port 106 to the outlet port 108 in the second position.

The valve switch 110 includes at least one seal 206 disposed at an interface between the valve body 102 and the valve switch 110. The at least one seal 206 is configured to maintain a positive pressure of up to 30 cmH2O in the connector 100 in use. This can allow a unidirectional fluid flow from the respective inlet port to the outlet port 108 and may prevent exhalation of air from the patient within the breathing circuit. The connector 100 is also designed to reduce air resistance while maintaining positive pressure. For example, connector 100 may be able to maintain the pressure of up to 30 cmH2O without leakage to the external environment. In one non-limiting example, the at least one seal 206 can be a ring made of rubber that is positioned within the valve switch 110 to minimize leakage during air exchange. It can be appreciated that the at least one seal 206 can be made of other types of material.

FIG. 3A shows a side view of a second inlet port 106 of the connector 100 of FIG. 1, according to an example embodiment while FIG. 3B shows a side view of the connector 100 of FIG. 3A with the valve switch 110 and the cover 208 removed. In the example embodiment shown in FIGS. 3A-3B, the valve switch 110 is at the second position whereby the second inlet port 106 is fluidically connected to the outlet port 108 while the first inlet port 104 is fluidically sealed from the outlet port 108. The removable cap 112 is used to physically seal the first inlet port 104 port to maintain cleanliness. The second inlet port 106 is fluidly connected to the second fluid source and the outlet port 108 is fluidically connected to the patient via the filter device. The second inlet port 106 may be a transport ventilator port that is connected to a transport ventilator that is used when transporting the patient. The through connection can allow fluid (e.g. air from the transport ventilator) to flow from the second fluid source unidirectionally (see arrows 302) through the connector 100 to the patient via the filter device (e.g. HME filter).

The following describes the steps of an example when the connector 100 is in use. When a patient has to be connected to both the transport and ICU ventilator, both ventilators will be turned on before the user switches the valve switch 110. Positive pressure will be present on both ends and within the chambers of the connector 100. Thus, when the user switches the valve connection, the pressure will be maintained constantly. The connection of the valve switch 110 and the valve body 102 is designed for a seal (or air-tight) fit to prevent pressure lost. The at least one seal 206 present in the valve switch 110 (as shown in FIGS. 2B and 3B) may be used to provide a seal fit between the valve switch 110 and the valve body 102.

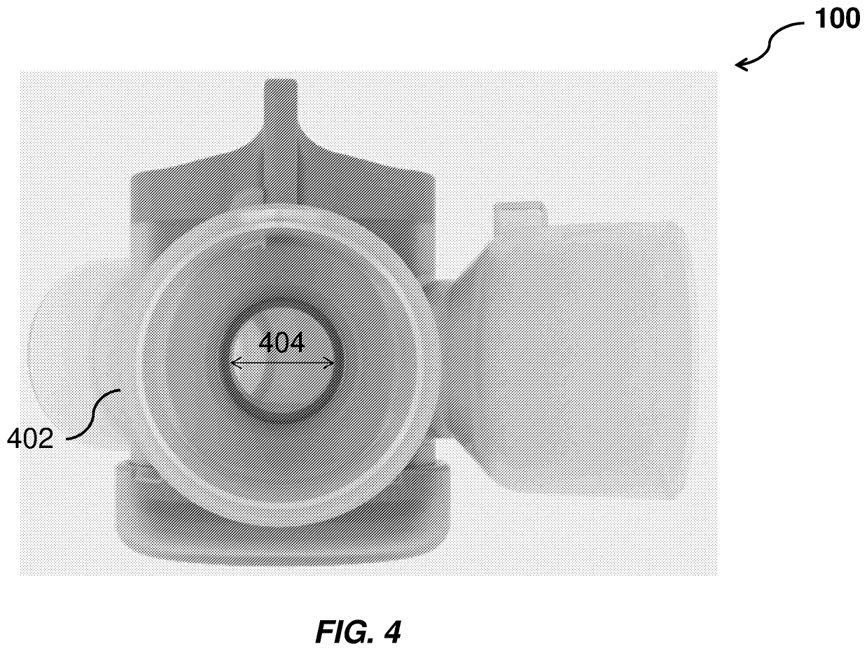

FIG. 4 shows a cross-sectional close-up view of a port 402 of the connector 100 of FIG. 1, according to an example embodiment. The port 402 shown in FIG. 4 may be the first inlet port 104 or the second inlet port 106. The port 402 may also be the outlet port 108. The port 402 may have an internal diameter 404 of substantially the same dimension as an internal diameter of the filter device (e.g. HME filter). In this way, airway resistance is not increased when the pressurised air is flowing from the inlet ports 104, 106 (e.g. ICU ventilator or transport ventilator) into the outlet port 108 (e.g. HME filter) and the connector 100 can be used in current standard filter devices and fluid sources.

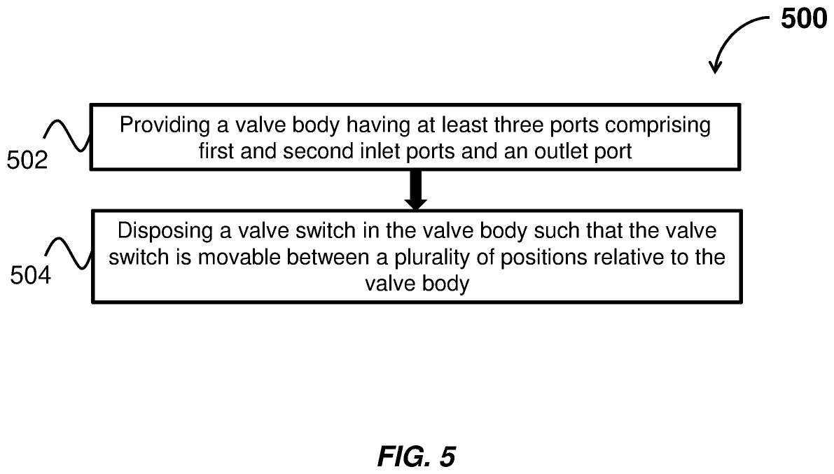

FIG. 5 shows a flow chart illustrating a method 500 for assembling a connector for a fluidic circuit, according to the example embodiments. The method includes at step 502, providing a valve body having at least three ports comprising first and second inlet ports and an outlet port. At step 504, the method includes disposing a valve switch in the valve body such that the valve switch is movable between a plurality of positions relative to the valve body. In a first position, the valve switch is configured to fluidically connect the first inlet port to the outlet port, and fluidically seal the second inlet port from the outlet port. In a second position, the valve switch is configured to fluidically connect the second inlet port to the outlet port, and fluidically seal the first inlet port from the outlet port.

The step of attaching the valve switch to the valve body comprises disposing the valve switch in the receptacle such that the valve switch is rotatable between the plurality of positions. The method further includes disposing at least one seal at an interface between the valve body and valve switch such that the at least one seal maintains a positive pressure of up to 30 cmH2O in the connector in use. The step of attaching the valve switch to the valve body comprises positioning the valve switch such that the visual indicator indicates which of the first and second inlet ports is opened.

The connector 100 for a fluidic circuit as described herein may have an overmount design to prevent the reduction in diameters and thus may prevent an increase in airway resistance. The connector 100 may prevent exhalation of air from the patient to the environment. The connector 100 can also fit current standardized breathing circuit and accommodate a closed circuit suction catheter. The valve switch 110 can minimize risk of human error by fluidically connecting to a desired inlet port and fluidically sealing the other inlet port.

The connector 100 may also provide a disposable valve attached to the breathing circuit so as to allow the patient to be switched from the ICU ventilator to the transport ventilator and vice versa without significant loss of airway pressure and minimize aerosolization to the environment. The connector 100 can be attached to the breathing circuit immediately post intubation and may reduce risks to the patient and healthcare personnel by maintaining airway pressure for the patient and minimizing aerosolization exposure to the healthcare personnel.

While exemplary embodiments have been presented in the foregoing detailed description of the invention, it should be appreciated that a vast number of variations exist.

It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A connector for a fluidic circuit, the connector comprising:
a valve body having at least three ports comprising first and second inlet ports and an outlet port; and
a valve switch attached to the valve body, the valve switch being movable between a plurality of positions relative to the valve body;
wherein, in a first position, the valve switch is configured to fluidically connect the first inlet port to the outlet port, and fluidically seal the second inlet port from the outlet port; and
wherein, in a second position, the valve switch is configured to fluidically connect the second inlet port to the outlet port, and fluidically seal the first inlet port from the outlet port.

2. The connector of claim 1, wherein the first and second inlet ports are configured to be connected to first and second fluid sources, respectively, and wherein the outlet port is configured to be connected to a filter device.

3. The connector of claim 2, wherein the first and second inlet ports and the outlet port each comprise an internal diameter having a same dimension as an internal diameter of the filter device.

4. The connector of a claim 1, wherein the valve body comprises a receptacle fluidically connected to each of the outlet port and the first and the second inlet ports, and wherein the valve switch is disposed in the receptacle such that the valve switch is rotatable between the plurality of positions.

5. The connector of claim 4, wherein the outlet port, the first inlet port and the second inlet port are angularly spaced from each other.

6. The connector of claim 5, wherein the valve switch comprises a plurality of holes configured to selectively connect the first inlet port to the outlet port in the first position, and to selectively connect the second inlet port to the outlet port in the second position.

7. The connector of a claim 1, further comprising at least one seal disposed at an interface between the valve body and the valve switch, wherein the at least one seal is configured to maintain a positive pressure of up to 30 cmH2O in the connector in use.

8. The connector of claim 1, wherein the valve switch further comprises a visual indicator configured to indicate which of the first and second inlet ports is opened.

9. A fluidic circuit comprising:
a first fluid source;
a second fluid source; and
a connector comprising:
a valve body having at least three ports comprising first and second inlet ports and an outlet port; and
a valve switch attached to the valve body, the valve switch being movable between a plurality of positions relative to the valve body,
wherein, in a first position, the valve switch is configured to fluidically connect the first inlet port to the outlet port, and fluidically seal the second inlet port from the outlet port,
wherein, in a second position, the valve switch is configured to fluidically connect the second inlet port to the outlet port, and fluidically seal the first inlet port from the outlet port, and
wherein the first and second inlet ports of the connector are configured to be connected to the first and the second fluid sources respectively.

10. The fluidic circuit of claim 9, wherein the first fluid source comprises a first ventilator and the second fluid source comprises a second ventilator, and wherein the outlet port is configured to be connected to a filter device.

11. The fluidic circuit of claim 10, wherein the first ventilator comprises an intensive care unit ventilator and the second ventilator comprises a transport ventilator.

12. A method for assembling a connector for a fluidic circuit, the method comprising:
providing a valve body having at least three ports comprising first and second inlet ports and an outlet port; and
disposing a valve switch in the valve body such that the valve switch is movable between a plurality of positions relative to the valve body;
wherein, in a first position, the valve switch is configured to fluidically connect the first inlet port to the outlet port, and fluidically seal the second inlet port from the outlet port; and
wherein, in a second position, the valve switch is configured to fluidically connect the second inlet port to the outlet port, and fluidically seal the first inlet port from the outlet port.

13. The method of claim 12, wherein the valve body comprises a receptacle fluidically connected to each of the outlet port and the first and the second inlet ports, and attaching the valve switch to the valve body comprises disposing the valve switch in the receptacle such that the valve switch is rotatable between the plurality of positions.

14. The method of claim 12, further comprising disposing at least one seal at an interface between the valve body and the valve switch such that the at least one seal maintains a positive pressure of up to 30 cmH2O in the connector in use.

15. The method of claim 12, wherein the valve switch further comprises a visual indicator, and wherein attaching the valve switch to the valve body comprises positioning the valve switch such that the visual indicator indicates which of the first and second inlet ports is opened.

16. The connector of claim 1, wherein the each of the first and second inlet ports comprises a limiter configured to position the valve switch at a respective one of the first and second positions.
